(19) United States
(12) Patent Application Publication
(10) Pub. No.: US 2018/0106731 A1
(43) Pub. Date: Apr. 19, 2018

(54) SEMICONDUCTOR DEVICE INSPECTION APPARATUS AND METHOD OF DRIVING THE SAME

(71) Applicant: SAMSUNG ELECTRONICS CO., LTD., SUWON-SI (KR)

(72) Inventors: MIN HO RIM, HWASEONG-SI (KR); MYUNG SU OH, HWASEONG-SI (KR); JUNG SOO KIM, HWASEONG-SI (KR); YU SIN YANG, SEOUL (KR); CHUNG SAM JUN, SUWON-SI (KR); YUN JUNG JEE, SEONGNAM-SI (KR)

(21) Appl. No.: 15/672,696

(22) Filed: Aug. 9, 2017

(30) Foreign Application Priority Data
Oct. 18, 2016 (KR) 10-2016-0135090

(51) Int. Cl. G01N 21/95; G01N 21/956

(52) U.S. Cl. CPC G01N 21/9501; G01N 2201/066; G01N 21/956

(57) ABSTRACT

A semiconductor device inspecting apparatus includes a light source for emitting light to a semiconductor pattern. The semiconductor pattern includes a structure that reflects the light from the light source. The semiconductor device inspecting apparatus further includes an objective optical system disposed in a path of the reflected light from the semiconductor pattern, and a first noise filter disposed in a path of the reflected light having passed through the objective optical system, the first noise filter including at least one bar pattern that filters a diffraction noise of the light. The semiconductor device inspecting apparatus additionally includes a second noise filter disposed in a path of the filtered light from the first noise filter, the second noise filter including an outer frame surrounding a central portion. The semiconductor device inspecting apparatus further includes a first photodetector detecting the light having passed through the second noise filter.

### CROSS-REFERENCE TO RELATED APPLICATION

This application claims priority under 35 U.S.C. § 119 to Korean Patent Application No. 10-2016-0135090 filed on Oct. 18, 2016 in the Korean Intellectual Property Office, the disclosure of which is incorporated by reference herein in its entirety.

### TECHNICAL FIELD

The present inventive concept relates to a semiconductor device inspection apparatus and a method of driving the same.

### DISCUSSION OF THE RELATED ART

Currently, semiconductor devices are advancing in a direction toward high-speed operation at low voltage, and methods of manufacturing a semiconductor device are advancing in a direction of increased integration. Therefore, patterns of highly-scaled and highly-integrated semiconductor devices may be spaced at fine pitches with fine widths.

With the miniaturization of semiconductor devices, requirements for an inspection apparatus that can inspect whether or not a semiconductor device is defective have increased. Particularly, in a region where the change in density of a semiconductor pattern is large, an unclear image may be obtained due to noise of an image obtained by light irradiation.

### SUMMARY

According to an exemplary embodiment of the present inventive concept, a semiconductor device inspecting apparatus includes a light source for emitting light to a semiconductor pattern. The semiconductor pattern includes a structure that reflects the light from the light source. The semiconductor device inspecting apparatus further includes an objective optical system disposed in a path of the reflected light from the semiconductor pattern. The semiconductor device inspecting apparatus further includes a first noise filter disposed in a path of the reflected light having passed through the objective optical system, the first noise filter including at least one bar pattern that filters a diffraction noise of the light. The semiconductor device inspecting apparatus additionally includes a second noise filter disposed in a path of the filtered light from the first noise filter, the second noise filter including an outer frame surrounding a central portion. The central part blocks light and the outer frame passes light. The semiconductor device inspecting apparatus further includes a first photodetector detecting the light having passed through the second noise filter.

According to an exemplary embodiment of the present inventive concept, a method of driving a semiconductor device inspecting apparatus including emitting light to a semiconductor pattern. The light reflects from the semiconductor pattern. The method further includes passing the light reflected from the semiconductor pattern through an objective optical system. The method additionally includes filtering a diffraction noise of light having passed through the objective optical system using a first noise filter including at least one bar pattern. The method further includes blocking a central portion of an image formed by the light having passed through the first noise filter using a second noise filter, and passing the light through at least a part of an outer frame of the second noise filter. The outer frame surrounds the central portion. The method further includes detecting the light having passed through the second noise filter using a first photodetector.

According to an exemplary embodiment of the present inventive concept, a semiconductor device inspecting apparatus includes a light source that emits light to a semiconductor pattern, and an objective optical system that passes light therethrough. The semiconductor device inspecting apparatus further includes a first noise filter including a bar pattern including a plurality of bars separated from each other by a distance, that filters diffraction noise of received light, and that passes the received light therethrough. The semiconductor device inspecting apparatus additionally includes a second noise filter that blocks a portion of an image formed by the light that has passed through the first noise filter and includes an opening region and a first blocking region at least partially surrounded by the opening region. The semiconductor device inspecting apparatus further includes an imaging optical system that receives light from the second noise filter and outputs an image based on the received light, and a photodetector that receives the image.

### BRIEF DESCRIPTION OF THE DRAWINGS

The above and other aspects and features of the present inventive concept will become more apparent by describing in detail exemplary embodiments thereof, with reference to the accompanying drawings, in which:

FIG. 1 is a view showing the operation of a semiconductor device inspection apparatus according to an exemplary embodiment of the present inventive concept;

FIG. 2A is a plan view of a first noise filter included in the semiconductor device inspection apparatus according to an exemplary embodiment of the present inventive concept;

FIG. 2B is a plan view of a first noise filter included in a semiconductor device inspection apparatus according to an exemplary embodiment of the present inventive concept;

FIG. 3A is a plan view of a second noise filter included in the semiconductor device inspection apparatus according to an exemplary embodiment of the present inventive concept;

FIG. 3B is a plan view of a second noise filter included in a semiconductor device inspection apparatus according to an exemplary embodiment of the present inventive concept;

FIG. 4 is a plan view showing an example of a semiconductor device to be inspected by the semiconductor device inspection apparatus according to an exemplary embodiment of the present inventive concept;

FIG. 5 is a view showing the operation of the semiconductor device inspection apparatus according to an exemplary embodiment of the present inventive concept;

FIGS. 6A to 6C are views showing the operation of the semiconductor device inspection apparatus according to an exemplary embodiment of the present inventive concept;

FIG. 7 is a graph of the S/N ratio of an image of a semiconductor pattern obtained by the semiconductor device inspection apparatus according to an exemplary embodiment of the present inventive concept;

FIG. 8 is a view showing a semiconductor device inspection apparatus according to an exemplary embodiment of the present inventive concept; and

FIGS. 9A and 9B are plan views of second and third noise filters included in the semiconductor device inspection apparatus according to an exemplary embodiment of the present inventive concept.

### DETAILED DESCRIPTION OF THE EMBODIMENTS

Exemplary embodiments of the present inventive concept will be described more fully hereinafter with reference to the accompanying drawings.

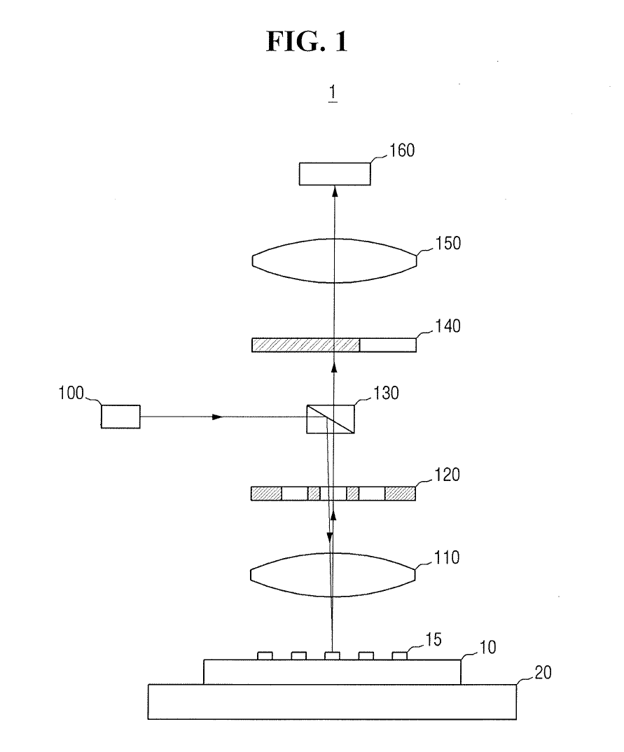

FIG. 1 is a view of a semiconductor device inspection apparatus according to an exemplary embodiment of the present inventive concept.

Referring to FIG. 1, the semiconductor device inspection apparatus according to an exemplary embodiment of the present inventive concept includes a light source 100, an objective optical system 110, a first noise filter 120, a beam splitter 130, a second noise filter 140, an imaging optical system 150, and a photodetector 160.

The light source 100 may emit light toward a semiconductor pattern 15 provided on a substrate 10. The light source 100 may include a light generator including a laser diode (LD) of various wavelengths, such as helium neon (HeNe) laser and argon (Ar) laser, and an optical system for making the light generated from the light generator into parallel light and emitting the parallel light to the outside of the light source 100. However, the present inventive concept is not limited thereto.

The light emitted from the light source 100 toward the semiconductor pattern 15 provided on the substrate 10 through the beam splitter 130. In other words, the beam splitter 130 may reflect the light emitted from the light source 100 toward the semiconductor pattern 15. The beam splitter 130 may transmit the light reflected from the semiconductor pattern 15 and passing through the objective optical system 110 and the first noise filter 120, and may transfer the light that has passed through the first noise filter 120 to a subsequent system including the second noise filter 140 and the imaging optical system 150.

The semiconductor pattern 15 provided on the substrate 10, for example, may be a semiconductor pattern formed on a silicon substrate. The substrate 10 may be disposed on a stage 20 of the semiconductor device inspection apparatus 1. In an exemplary embodiment of the present inventive concept, the semiconductor pattern 15 provided on the substrate 10 may be included in dynamic random-access memory (DRAM), and, the semiconductor pattern 15 provided on the substrate 10 may be included in a sense amplifier region or sub-word line region of DRAM.

The beam splitter 130 may reflect the light provided from the light source 100 toward the substrate 10 such that the reflected light is incident to substrate 10 at an angle substantially perpendicular to the substrate 10.

In an exemplary embodiment of the present inventive concept, the semiconductor device inspection apparatus 1 might not include the beam splitter 130. For example, the light generated from the light source 100 is incident toward the semiconductor pattern 15 or the surface of the substrate 10 at an acute angle, and the light reflected from the semiconductor pattern 15 or the surface of the substrate 10 enters the objective optical system 110 and the first noise filter 120 at an acute angle. Thus, the optical path between the incident light and the reflected light might not coincide. In this case, the semiconductor device inspection apparatus 1 might not include the beam splitter 130.

The objective optical system 110, which is spaced apart from the substrate 10 by a focal length of the objective optical system 110, obtains an image of the substrate 10 and the semiconductor pattern 15, magnifies the obtained image at an appropriate magnification, and transfers this magnified image to the subsequent system including the second noise filter 140 and the imaging optical system 150.

Although it is shown in FIG. 1 that the objective optical system 110 includes one lens, the present inventive concept is not limited thereto. In an exemplary embodiment of the present inventive concept, the objective optical system 110 may include a plurality of lenses spaced apart from each other by a predetermined distance, and thus, the objective optical system 110 may have a structure for increasing the quality of the image and/or improving a magnification of the image obtained from the substrate 10 and the semiconductor pattern 15.

The first noise filter 120 is disposed between the objective optical system 110 and the imaging optical system 150. Further, the first noise filter 120 performs noise filtering of image signals having passed through the objective optical system 110 and provides these noise-filtered image signals to the subsequent system including the second noise filter 140 and the imaging optical system 150.

The first noise filter 120 may be disposed over the objective optical system 110 to be aligned with the light passing through the objective optical system 110.

As shown in FIG. 1, the first noise filter 120 may be disposed between the objective optical system 110 and the imaging optical system 150, but the present inventive concept is not limited thereto. For example, the first noise filter 120 may directly receive the light reflected from the semiconductor pattern 15, and not the light passing through the objective optical system 110. In other words, the first noise filter 120 may be disposed between the objective optical system 110 and the substrate 10.

In this case, the objective optical system 110 may receive the light filtered by the first noise filter 120, magnify the filtered light, and provide the magnified light to the second noise filter 140.

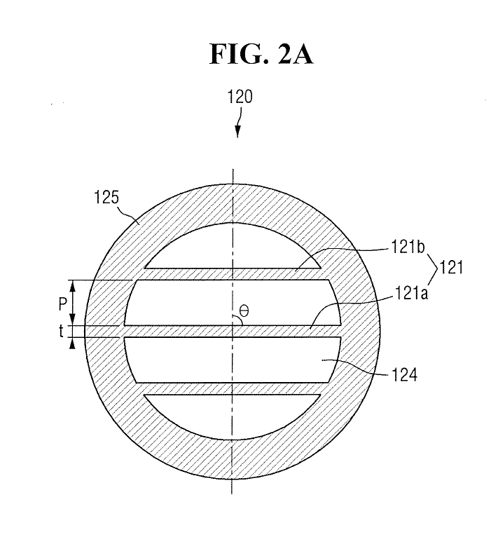

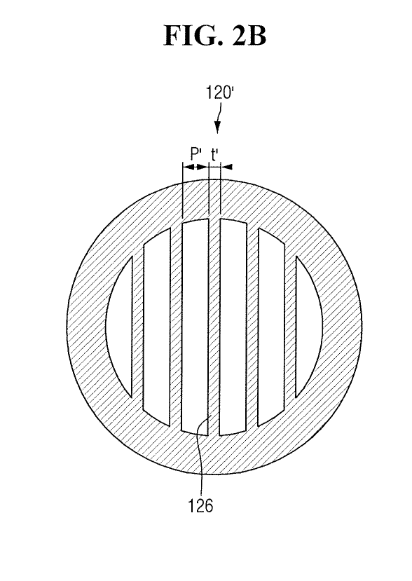

The operation of the first noise filter 120 will be described with reference to FIGS. 2A and 2B.

FIG. 2A is a plan view of the first noise filter 120 included in the semiconductor device inspection apparatus 1 according to an exemplary embodiment of the present inventive concept. FIG. 2B is a plan view of a first noise filter 120′ included in a semiconductor device inspection apparatus 1 according to an exemplary embodiment of the present inventive concept.

First, referring to FIG. 2A, the first noise filter 120 includes a circular outer frame 125 and an inner surface of the outer frame 125. The inner surface may include opening regions 124, a bar pattern 121 including one or more bars 121a and 121b spaced from each other at a predetermined interval.

The first noise filter 120 may remove diffraction noises generated when the light reflected from the semiconductor pattern 15 is repeatedly reflected by the semiconductor pattern 14.

For example, a diffraction pattern formed by the diffraction of the light reflected from the semiconductor pattern 15 may be incident to the first noise filter 120 with a predetermined directionality. In this case, the bar pattern 121 may overlap the diffraction noise pattern of the light incident to the first noise filter 120 by adjusting the distance P between the bar patterns 121, the area t of each bar 121a and 121b of the bar pattern 121 and the angle θ of the bar pattern 121 of the first noise pattern 120. The diffraction noise pattern overlapping the bar pattern 121 is filtered by the first noise filter 120, and only the light without the diffraction noise pattern passes through the first noise filter 120 to the beam splitter 130 or the second noise filter 140.

In an exemplary embodiment of the present inventive concept, the first noise filter 120 may be operated by a mechanical driving method. For example, as described above, the distance P between the bar patterns 121, the area t of the bar pattern 121 and the angle θ of the bar pattern 121 of the first noise pattern 120 may be changed depending on the semiconductor device to be measured by the semiconductor device inspection apparatus 1.

When the first noise filter 120 is operated by a mechanical driving method, the area t of the bar pattern 121, the distance P between the bars 121a and 121b of the bar patterns 121, and the angle θ of the bar pattern 121 may be adjusted by an actuator or a motor, for example, a micro electro mechanical system (MEMS) type motor.

However, the present inventive concept is not limited thereto, and the first noise filter 120 may include a spatial light modulator (SLM).

For example, the first noise filter 120 may include a grating light valve (GLV), an electro-optical element using a light-transmissive ceramic, liquid crystal, and the like. The first noise filter 120 including the SLM may block the diffraction noises, which are generated from the light reflected from the semiconductor pattern 15, by electromagnetically forming the bar pattern 121.

Referring to FIG. 2B, in the semiconductor device inspection apparatus according to an exemplary embodiment of the present inventive concept, the first noise filter 120′ may have a different structure from that of the first noise filter 120 of the aforementioned semiconductor device inspection apparatus 1.

For example, the first noise filter 120′ may be different from the first noise filter 120 in terms of the number of bars constituting a bar pattern 126, the distance P′ between each bar of the bar pattern 126, the area t′ of each bar of the bar pattern 126, and the angle of the bar pattern 126.

The first noise filter 120 and the first noise filter 120′ may filter the diffraction noises generated when inspecting regions of the semiconductor patterns 15 of the substrate 10. Regions inspected with the first noise filter 120 may be different from regions inspected with the first noise filter 120′. For example, the first noise filter 120 may filter the diffraction noise generated when inspecting the semiconductor pattern 15 on a sense amp region. In addition, the first noise filter 120′ may filter the diffraction noise generated when inspecting the semiconductor pattern 15 included in a sub-word line region.

In the semiconductor device inspection apparatus 1 according to an exemplary embodiment of the present inventive concept, both the first noise filter 120 and the first noise filter 120′ are included in one semiconductor device inspection apparatus 1, and may be used alternately. In addition, in the semiconductor device inspection apparatus 1, one first noise filter 120 is included, and, when beginning an inspection of a second region of the semiconductor pattern 15 after completing an inspection of a first region of the semiconductor pattern 15 on the substrate 10, the first noise filter 120 is modified into the first noise filter 120′ and then the second region may be inspected.

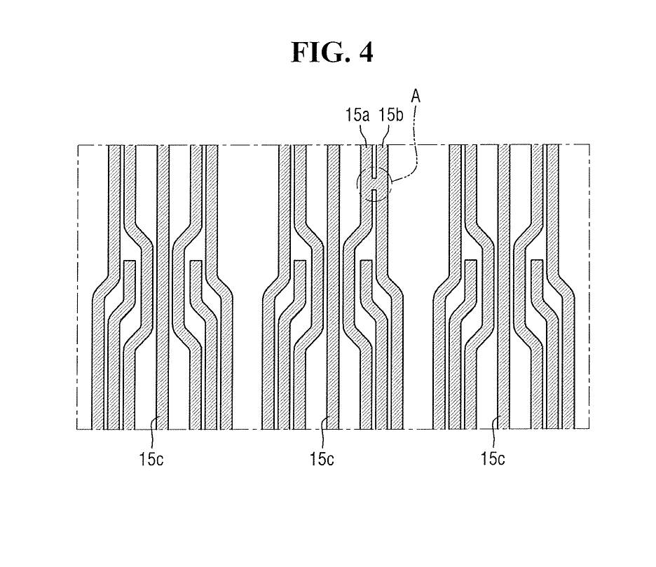

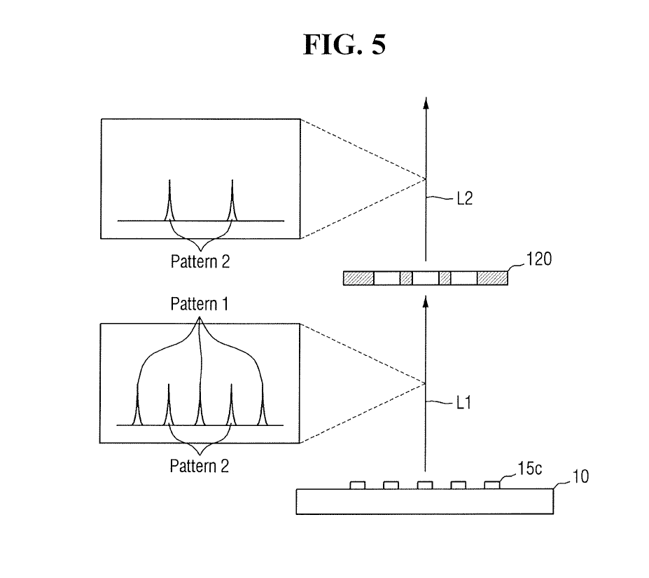

The operation of the first noise filter 120 will be described with reference to FIGS. 4 and 5.

FIG. 4 is a plan view showing an example of a semiconductor device to be inspected by the semiconductor device inspection apparatus 1 according to an exemplary embodiment of the present inventive concept. FIG. 5 is a view showing the operation of the semiconductor device inspection apparatus 1 according to an exemplary embodiment of the present inventive concept. In FIG. 5 the substrate 10, the semiconductor pattern 15 and the first noise filter 120 are shown. Referring to FIG. 4, the semiconductor pattern 15 to be inspected may include first to third semiconductor patterns 15a, 15b, and 15c. Here, since the first and second semiconductor patterns 15a and 15b have irregular shapes, pattern density is irregularly changed, and diffraction signals might not be generated depending on the relationship with other surrounding patterns. In addition, it is illustratively shown in FIG. 4 that the two patterns 15a and 15b have bridge defects A generated in the manufacturing process.

In addition, among the patterns 15a and 15b that have an irregular pattern density, regularly repeated patterns 15c exist. These regularly repeated patterns 15c, as described above, may be a cause of generating diffraction-induced noises to the incident and reflected light.

Therefore, the light L1 reflected from the semiconductor pattern 15 may include a diffraction noise component.

The semiconductor device inspection apparatus 1 according to an exemplary embodiment of the present inventive concept removes the diffraction noises caused by the regularly repeated patterns 15c using the first noise filter 120.

Referring to FIG. 5, the light L1 reflected from the semiconductor pattern 15 is provided to the first noise filter 120. As described above, the light L1 reflected from the semiconductor pattern 15 may pass through the objective optical system 110 before the light L1 is provided to the first noise filter 120.

The light L1 provided to the first noise filter 120 is subjected to a state in which signals included in an image of the semiconductor pattern 15 are mixed with diffraction noises generated by the regularly repeated semiconductor patterns 15c. In other words, as shown in FIG. 4, the semiconductor pattern 15 includes the regularly repeated semiconductor patterns 15c, and these regularly repeated semiconductor patterns 15c may generate a polarization noise to the light L1.

As shown in FIG. 5, the light L1 reflected from the semiconductor pattern 15 may include two kinds of light patterns (Pattern 1 and Pattern 2). Here, the first light pattern (Pattern 1) corresponds to the diffraction noise generated by the regularly repeated semiconductor patterns 15c. The diffraction noise may appear as a horizontal or vertical line shaped noise with respect to an optical image of the semiconductor pattern 15 obtained by the semiconductor device inspection apparatus 1.

In addition, the second light pattern (Pattern 2) is a pattern formed by an image of the semiconductor pattern 15. For example, the second light pattern (Pattern 2) is a light pattern including image signals of the semiconductor patterns 15a and 15b that do not form diffraction noises.

The light L1 incident on the first noise filter 120 includes the first light pattern (Pattern 1) including a diffraction noise and the second light pattern (Pattern 2) not including the diffraction noise, and the light L2 having passed through the first noise filter 120 only includes the second light pattern (Pattern 2) not including the diffraction noise.

The first noise filter 120 may adjust the area t of each of the bars of the bar pattern 121 and 126, the distance P between each of the bars of the bar pattern 121 and 126, and the angle θ of the bar pattern 121 and 126 of the first noise pattern 120 in response to the diffraction noise included in the light L1.

To set the area t of each of the bars of the bar pattern 121 and 126, the distance P between each of the bars of the bar pattern 121 and 126, and the angle θ of bar pattern 121 and 126 of the first noise pattern 120, an analysis of an image formed by the light L1 reflected from the semiconductor pattern 15 may be performed.

For example, in the light L1 reflected from the semiconductor pattern 15 and provided to the objective optical system 110, the horizontal or vertical line pattern generated by the regularly repeated semiconductor patterns 15c is analyzed to obtain data about area of the corresponding noise patterns, distance between the noise patterns, and rotational angle of the noise patterns.

Therefore, after obtaining the information about the noise pattern, adjustments to the first noise filter 120 may be initiated. For example, the first noise filter 120 may be set by setting the area t of each of the bars 121a and 121b of the bar pattern 121, the distance P between each of the bars 121a and 121b of the bar pattern 121, and the angle of the bar pattern 121 of the first noise filter 120 in accordance with the noise pattern by using the data about the area of the corresponding noise pattern, the distance between the noise pattern, and the rotational angle of the noise pattern. The first noise filter 120 may be disposed in the semiconductor device inspection apparatus 1.

Referring to FIG. 1 again, the light, from which a diffraction noise has been removed by the first noise filter 120, passes through the beam splitter 130 and is provided to the second noise filter 140.

As described above, when the semiconductor device inspection apparatus 1 according to an exemplary embodiment of the present inventive concept does not include the beam splitter 130, the light having passed through the first noise filter 120 may be provided to the second noise filter 140.

The second noise filter 140 may be disposed between the beam splitter 130 and the imaging optical system 150. As described above, when the semiconductor device inspection apparatus 1 according to an exemplary embodiment of the present inventive concept does not include the beam splitter 130, the second noise filter 140 may be disposed between the first noise filter 120 and the imaging optical system 150.

The second noise filter 140 transmits the light having passed through the first noise filter 120. In other words, the light from which a diffraction noise has been removed is provided to the imaging optical system 150.

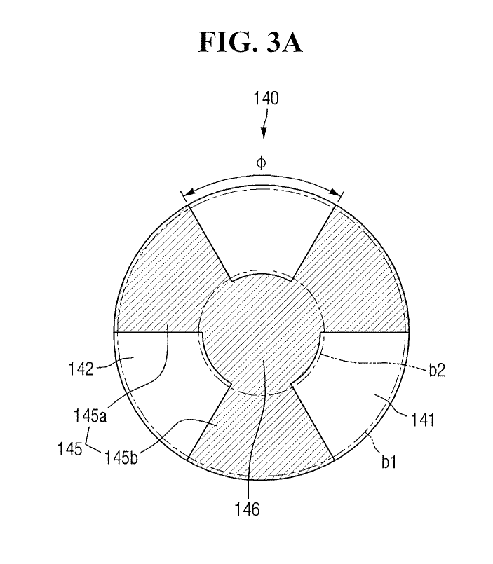

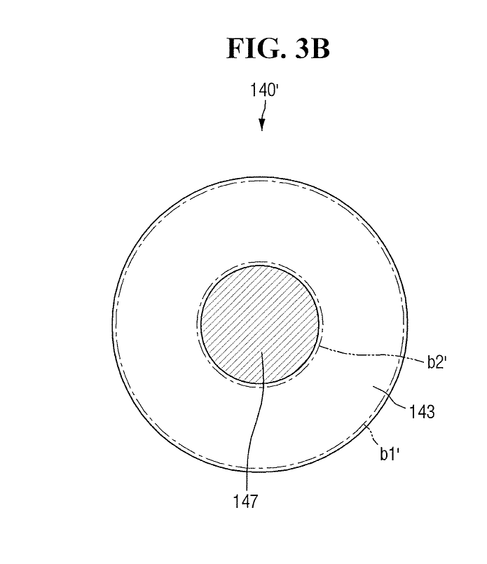

FIG. 3A is a plan view of the second noise filter 140 included in the semiconductor device inspection apparatus 1 according to an exemplary embodiment of the present inventive concept. FIG. 3B is a plan view of a second noise filter 140′ included in a semiconductor device inspection apparatus 1 according to an exemplary embodiment of the present inventive concept.

First, referring to FIG. 3A, the second noise filter 140 may include an outer frame b1 and a central portion b2.

The central portion b2 may have a concentric shape for sharing a same center as the second noise filter 140. In an exemplary embodiment of the present inventive concept, the central portion b2 may block the light component, which is in the light provided to the second noise filter 140, passing through a low numerical aperture (NA) region of the second noise filter 140. For example, the central portion b2 of the second noise filter 140 includes a blocking region 146 that blocks a part of the light provided to the second noise filter 140.

The outer frame b1 corresponds to other regions of the semiconductor pattern 15 excluding the region blocked by the blocking region 146 of the central portion b2 in the second noise filter 140. The outer frame b1 of the second noise filter 140 may selectively allow through an opening and block an outer region of the second noise filter 140. In other words, in an exemplary embodiment of the present inventive concept, the outer frame b1 may selectively transmit and block the light by blocking regions 145 and opening regions 141 and 142.

Referring to FIG. 3A, the outer frame b1 of the second noise filter 140 is divided into three parts of three blocking regions 145 and opening regions 141 and 142. In an exemplary embodiment of the present inventive concept, the division type (n=1, n is a natural number) and angle φ between the blocking regions in the outer frame b1 of the second noise filter 140 may be adjusted.

In an exemplary embodiment of the present inventive concept, the outer frame b1 may selectively block the light component, which is in the light provided to the second noise filter 140, passing through a high numerical aperture (NA) region of the second noise filter 140.

Referring to FIG. 3B, the shape of a second noise filter according to an exemplary embodiment of the present inventive concept is shown. As shown in FIG. 3B, the second noise filter 140′ may block only a central portion b2′, and may completely open an outer frame b1′. The second noise filter 140′ may include a blocking region 147 in the central portion b2′ and an opening region in the outer frame b1′ surrounding the central portion b2′. In this case, in the light provided to the second noise filter 140′, the light component passing through the low NA region may be blocked, and the light component passing through the high NA region may be completely transmitted.

In an exemplary embodiment of the present inventive concept, the second noise filter 140 may be operated by a mechanical driving method. For example, as described above, the division type (e.g., the number of blocking regions 145) and the angle φ between the blocking regions 145 in the outer frame b1 of the second noise filter 140 may be changed depending on the semiconductor device to be inspected by the semiconductor device inspection apparatus 1.

When the second noise filter 140 is operated by a mechanical driving method, the division type and the angle φ between the blocking regions 145 in the outer frame b1 of the second noise filter 140 may be adjusted by an actuator or a motor, for example, a micro electro mechanical system (MEMS) type motor.

However, the present inventive concept is not limited thereto, and the second noise filter 140 may be configured to include a spatial light modulator (SLM).

For example, the second noise filter 140 may include a grating light valve (GLV), an electro-optical element using light-transmissive ceramic, liquid crystal, and the like. The second noise filter 140 including SLM may block the light provided to the second noise filter 140 by electromagnetically forming the blocking region 145.

Hereinafter, the operation of the second noise filter 140 will be described.

Referring to FIG. 1 again, the imaging optical system 150 may magnify an image of the semiconductor pattern 15, the light of which having passed through the second image filter 140, and may provide the magnified image to the photodetector 160. The imaging optical system 150 may be disposed on an extension line where the objective optical system 110, the first noise filter 120, and the second noise filter 140 are aligned.

Although it is shown in FIG. 1 that the imaging optical system 150 includes one lens, the present inventive concept is not limited thereto. In an exemplary embodiment of the present inventive concept, the imaging optical system 150 includes a plurality of lenses spaced apart from each other by a predetermined distance, and thus, the imaging optical system 150 may have a structure of increasing the quality of an image and/or improving the magnification of the image obtained from the substrate 10 and the semiconductor pattern 15.

Further, the present inventive concept is not limited thereto. For example, the semiconductor device inspection apparatus 1 according to an exemplary embodiment of the present inventive concept may also include a plurality of imaging optical systems 150. For example, the semiconductor device inspection apparatus 1 may have a structure where the plurality of imaging optical systems 150 are arranged in a vertical line and the light image outputted from one imaging optical system 150 is inputted to another imaging optical system 150. In this case, in an exemplary embodiment of the present inventive concept, the magnifications of each imaging optical system 150 of the plurality of imaging optical systems 150 may be different from one another. Further, the plurality of imaging optical systems 150 may be aligned on an extension line where the first noise filter 120 and the second noise filter 140 are disposed on.

Although it is shown in FIG. 1 that the second noise filter 140 is disposed between the beam splitter 130 and the imaging optical system 150, and the light having passed through the second noise filter 140 is provided to the imaging optical system 150, the present inventive concept is not limited thereto. In an exemplary embodiment of the present inventive concept, the imaging optical system 150 may be disposed between the second noise filter 140 and the beam splitter 130, and the light having passed through the imaging optical system 150 is provided to the second noise filter 140, to provide a noise.

The photodetector 160, for example, may include an image sensor, such as a charge-coupled device (CCD). However, the present inventive concept is not limited thereto, and the photodetector 160 may include an image sensor including a complementary metal-oxide sensor (CMOS).

The photodetector 160 may be aligned on an extension line where the second noise filter 140 and the imaging optical system 150 are disposed. The photodetector 160 receives light that passes through the second noise filter 140 which removes a noise from the light. The photodetector 160 converts the light into electric signals to create image files and the like. In addition, the semiconductor device inspection apparatus 1 according to an exemplary embodiment of the present inventive concept may additionally include a storage unit for storing the image files created by the photodetector 160.

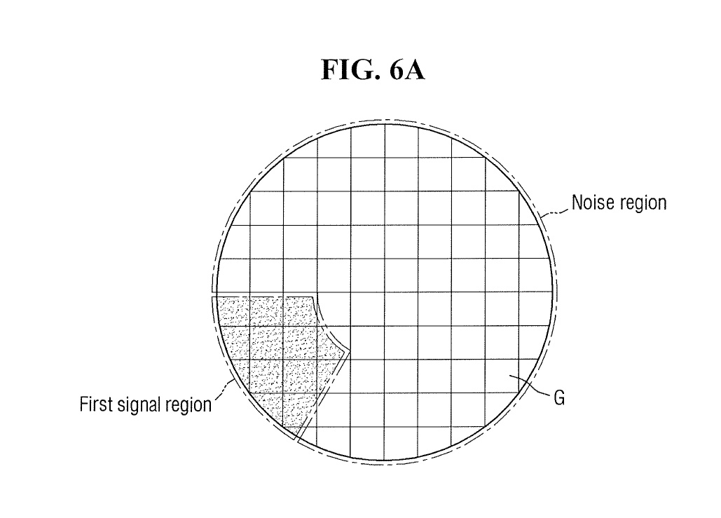

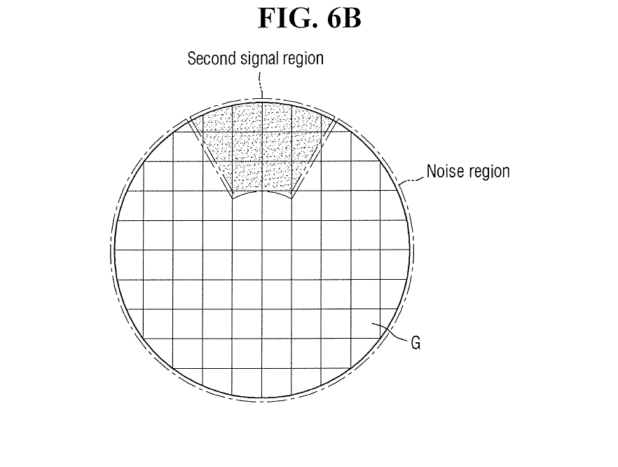

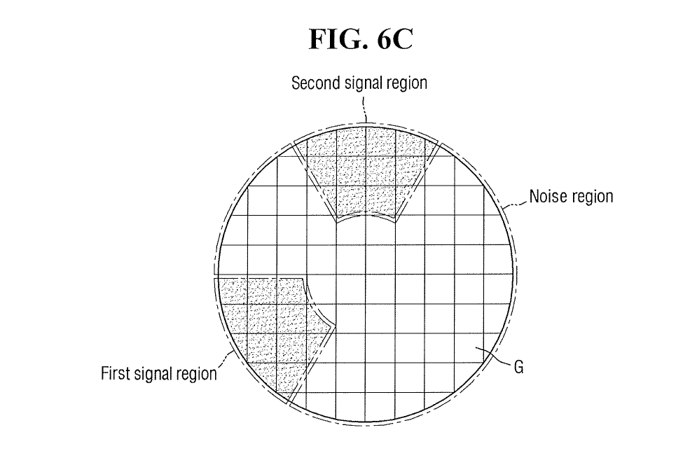

FIGS. 6A to 6C are views showing the operation of the semiconductor device inspection apparatus 1 according to an exemplary embodiment of the present inventive concept.

Referring to FIG. 6A, in the semiconductor device inspection apparatus 1 according to an exemplary embodiment of the present inventive concept, the image formed by the light passing through the first noise filter 120 and provided to the second noise filter 140 may be divided into a noise region and a first signal region.

Referring to FIG. 6B, the image obtained of a region different from a region measured in FIG. 6A may be divided into a second signal region and a noise region.

To divide an image into the signal regions and noise regions shown in FIGS. 6A and 6B, analysis work of the image formed by the light provided to the second noise filter 140 may be performed.

In the image analysis work, a plurality of grids G are classified with respect to the light provided to the second noise filter 140, and each of the grids G is repeatedly opened and blocked, to divide regions where defective patterns to be inspected (for example, bridge defects of FIG. 4) are identified and regions where the defective patterns are not identified.

For example, in the case where the identification of defective patterns becomes difficult due to noise increases when any grid G is opened, the region of the corresponding grid G is identified as a noise region. Unlike this, in the case where the identification of defective patterns becomes easy due to noise decreases when any grid G is opened, the region of the corresponding grid G is identified as a signal region. Through this image analysis work, a noise region is identified with respect to each of the regions of the semiconductor pattern 15 and substrate 10 to be inspected, and the pattern of the second noise filter 140 for blocking this noise region may be configured.

In an exemplary embodiment of the present inventive concept, the signal region of the image formed by the light provided to the second noise filter 140 may be identified only in the outer frame region b1 and b1′.

In FIG. 6C, the first and second signal regions summed from FIGS. 6A and 6B and a noise region are shown. Therefore, the second noise filter 140 may be configured to form an opening region 141 and 142 for opening the summed first and second signal regions and a blocking region 145 for blocking the noise region, and may be disposed in front of (e.g., before) the imaging optical system 150.

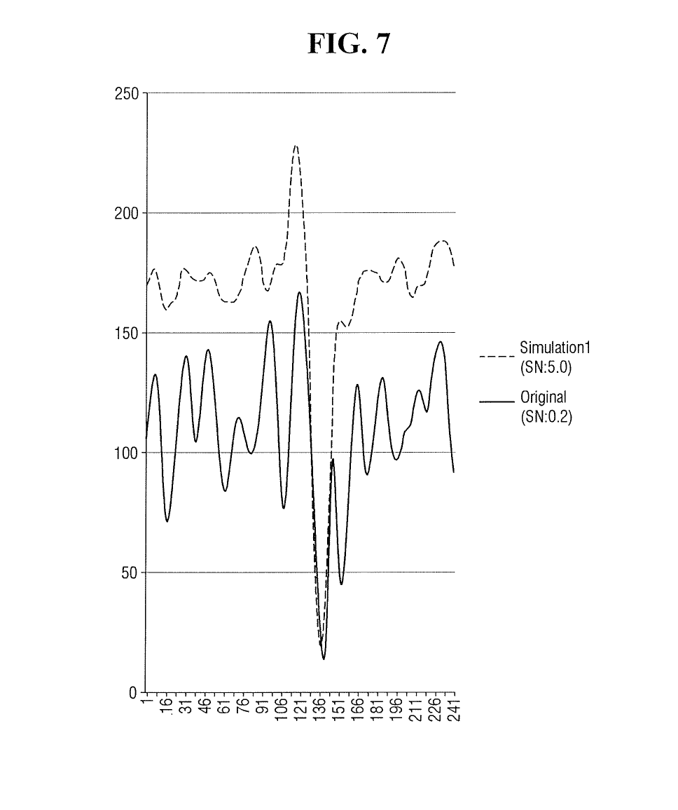

FIG. 7 is a graph of the S/N (signal/noise) ratio of an image of a semiconductor pattern 15 obtained by the semiconductor device inspection apparatus 1 according to an exemplary embodiment of the present inventive concept.

Referring to FIG. 7, a case (Original) of not passing through the first and second noise filters of the semiconductor device inspection apparatus 1 according to an exemplary embodiment of the present inventive concept, and a case (Simulation) of passing through the first and second noise filters 120 and 140 are shown.

As shown in FIG. 7, in the case of passing through the first and second noise filters 120 and 140, it can be ascertained that the S/N (signal/noise) ratio has greatly increased.

In the semiconductor device inspection apparatus 1 according to an exemplary embodiment of the present inventive concept, diffraction noises are removed from the light reflected from the semiconductor pattern 15 by the first noise filter 120, and the filtered light selectively passes through only the signal region of the outer frame of the second noise filter 140 to be transferred to the photodetector 160. Therefore, the diffraction noises and the signals of the light transferred to the photodetector 160 may be selectively filtered by noise filters 120 and 140 twice.

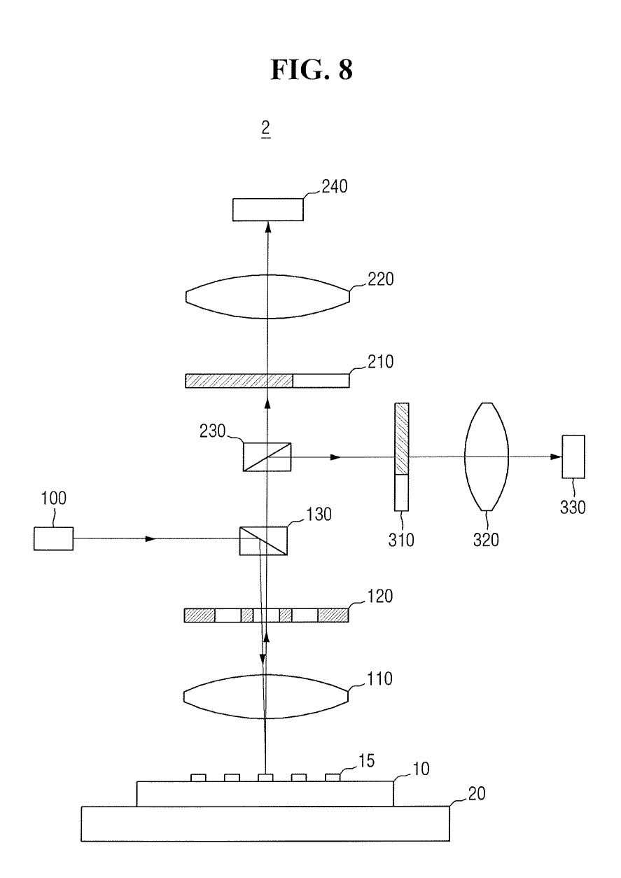

FIG. 8 is a view of a semiconductor device inspection apparatus 2 according to an exemplary embodiment of the present inventive concept.

Referring to FIG. 8, the semiconductor device inspection apparatus 2 according to an exemplary embodiment of the present inventive concept includes a light source 100, an objective optical system 110, a first noise filter 120, a first beam splitter 130, a second beam splitter 230, a second noise filter 210, a third noise filter 310, a first imaging optical system 220, a second imaging optical system 320, a first photodetector 240, and a second photodetector 330.

The semiconductor device inspection apparatus 2 according to an exemplary embodiment of the present inventive concept is different from the semiconductor device inspection apparatus 1 according to an exemplary embodiment of the present inventive concept in that semiconductor device inspection apparatus 2 includes two or more photodetectors 240 and 330, and additionally includes noise filters 210 and 310 and imaging optical systems 220 and 320 corresponding to the photodetectors 240 and 330.

The light emitted from the light source 100 is reflected by the first beam splitter 130 to be radiated onto the substrate 10 and the semiconductor pattern 15. The light reflected from the semiconductor pattern 15 passes through the first beam splitter 130, and is simultaneously split by the second beam splitter 230 to be respectively provided to the second noise filter 210 and the third noise filter 310.

Similar to the semiconductor device inspection apparatus 1 according to an exemplary embodiment of the present inventive concept, the semiconductor device inspection apparatus 2 according to an exemplary embodiment of the present inventive concept might not include the first beam splitter 130.

For example, the light generated from the light source 100 is incident toward the surface of the semiconductor pattern 15 at an acute angle, and the light reflected from the surface of the semiconductor pattern 15 enters the objective optical system 110 and the first noise filter 120 at an acute angle. Thus, the optical path between the incident light and the reflected light may not coincide. In this case, the semiconductor device inspection apparatus 2 might not include the first beam splitter 130.

The semiconductor device inspection apparatus 2 according to an exemplary embodiment of the present inventive concept may be provided with two photodetectors 240 and 330 for obtaining an image of the semiconductor pattern 15. In an exemplary embodiment of the present inventive concept, the first photodetector 240 and the second photodetector 330 may be different from each other.

For example, the second photodetector 240 may be a photodetector for a bright-field microscope, and the third photodetector 330 may be a photodetector for a dark-field microscope.

For example, the first photodetector 240 receives the reflected light directly reflected from the semiconductor pattern 15 to obtain a bright-field image of the semiconductor pattern 15. In addition, the second photodetector 330 receives the scattered light scattered from the semiconductor pattern 15 to obtain a dark-field image of the semiconductor pattern 15.

Accordingly, for the first photodetector 230 and the second photodetector 330 each performing different image obtaining methods from each other, different noise components may be included and provided to each of them.

Generally, the diffraction noise generated by the repeatedly formed semiconductor pattern 15 influences commonly generated and obtained images regardless of a bright-field microscope or a dark-filed microscope.

Therefore, the diffraction noise on the image of the semiconductor pattern 15 may be removed by using the first noise filter 120 disposed between the objective optical system 110 and the second beam splitter 230.

In addition, when the first photodetector 240 is a bright field detector and the second photodetector 330 is a dark field detector, the configurations of the second noise filter 210 and third noise filter 320 providing light to the first photodetector 240 and the second photodetector 330, respectively, may also be different from each other.

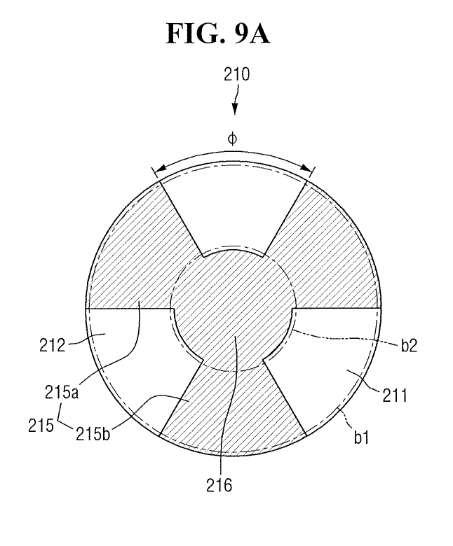

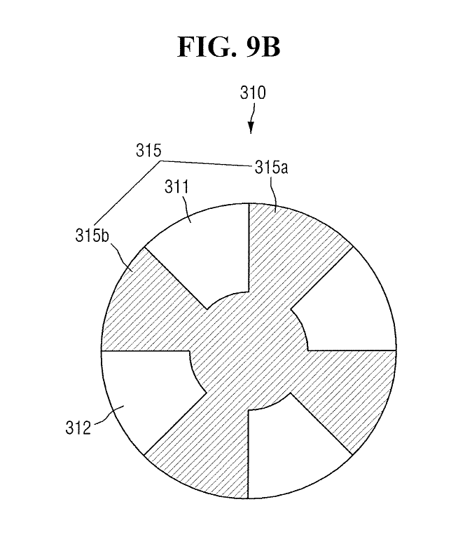

FIGS. 9A and 9B are plan views of second 210 and third 310 noise filters included in the semiconductor device inspection apparatus 2 according to an exemplary embodiment of the present inventive concept.

FIG. 9A shows a shape of the second noise filter 210. The second noise filter 210 is similar to the aforementioned second noise filter 140 in that this second noise filter 210 includes an outer frame b1 and a central portion b2. The central portion b2 is blocked by a blocking region 216, and the outer frame b1 is selectively opened and blocked by the blocking region 215 and opening regions 211 and 212.

FIG. 9B shows a shape of the third noise filter 310. In an exemplary embodiment of the present inventive concept, the shapes of the second noise filter 210 and the third noise filter 310 may be different from each other. For example, as shown in FIG. 9B, the division type of blocking regions 315a and 315b and the interval between opening regions 311 and 312 of the third noise filter 310 may be different from those of the second noise filter 210.

While the present inventive concept has been particularly shown and described with reference to exemplary embodiments thereof, it will be apparent to those of ordinary skill in the art that various changes in form and detail may be made thereto without departing from the spirit and scope of the present inventive concept.

What is claimed is:

1. A semiconductor device inspecting apparatus, comprising:
a light source for emitting light to a semiconductor pattern, wherein the semiconductor pattern includes a structure that reflects the light from the light source;
an objective optical system disposed in a path of the reflected light from the semiconductor pattern;
a first noise filter disposed in a path of the reflected light having passed through the objective optical system, the first noise filter including at least one bar pattern that filters a diffraction noise of the light;
a second noise filter disposed in a path of the filtered light from the first noise filter, the second noise filter including an outer frame surrounding a central portion, wherein the central part blocks light and the outer frame passes light; and
a first photodetector detecting the light having passed through the second noise filter.

2. The semiconductor device inspecting apparatus of claim 1,
wherein the bar pattern of the first noise filter overlaps the diffraction noise of the light reflected from the semiconductor pattern to remove the diffraction noise of the light passing through the first noise filter.

3. The semiconductor device inspecting apparatus of claim 1, further comprising:
an imaging optical system for receiving the light that has passed through the second noise filter, forming the light into an image and providing the image to the first photodetector.

4. The semiconductor device inspecting apparatus of claim 1, further comprising:
a beam splitter splitting the light that has passed through the first noise filter,
a second photodetector different from the first photodetector, and
the light that has passed through the beam splitter is divided into a first light to be provided to the first photodetector and a second light to be provided to the second photodetector.

5. The semiconductor device inspecting apparatus of claim 4,
wherein the first photodetector is a bright-field detector, and the second photodetector is a dark-field detector.

6. The semiconductor device inspecting apparatus of claim 5,
wherein the second noise filter includes a bright-field filter providing the first light filtered by the bright-field detector and a dark-field filter providing the second light filtered by the dark-field detector.

7. The semiconductor device inspecting apparatus of claim 6,
wherein a shape of an outer frame of the bright-field filter is different from a shape of an outer frame of the dark-field filter.

8. The semiconductor device inspecting apparatus of claim 1,
wherein the semiconductor pattern is disposed in a dynamic random-access memory circuit, and includes a first region and a second region different from the first region.

9. The semiconductor device inspecting apparatus of claim 8,
wherein the first region includes a sense amplifier region, and the second region includes a sub-word line region.

10. The semiconductor device inspecting apparatus of claim 1,
wherein the first noise filter and the second noise filter are operated by a mechanical driving method.

11. The semiconductor device inspecting apparatus of claim 1,
wherein each of the first noise filter and the second noise filter includes a spatial light modulator (SLM).

12. A method of driving a semiconductor device inspecting apparatus, comprising:
emitting light to a semiconductor pattern, wherein the light reflects from the semiconductor pattern;
passing the light reflected from the semiconductor pattern through an objective optical system;
filtering a diffraction noise of light having passed through the objective optical system using a first noise filter including at least one bar pattern;
blocking a central portion of an image formed by the light having passed through the first noise filter using a second noise filter, and passing the light through at least a part of an outer frame of the second noise filter, wherein the outer frame surrounds the central portion; and
detecting the light having passed through the second noise filter using a first photodetector.

13. The method of claim 12, further comprising:
dividing the light having passed through the first noise filter into first light and second light;
blocking a central portion of an image formed by the first light and passing the first light through at least a part of the outer frame of the second noise filter, wherein the outer frame surrounds the central portion of the image formed by the first light, using the second noise filter;
blocking a central portion of an image formed by the second light and passing the second light through at least a part of an outer frame of a third noise filter, wherein the outer frame surrounds the central portion of the image formed by the second light, using the third noise filter; and
detecting the first light and second light having respectively passed through the second noise filter and the third noise filter using the first photodetector and a second photodetector, respectively.

14. The method of claim 13,
wherein the first photodetector is a bright-field detector, and the second photodetector is a dark-field detector.

15. The method of claim 13,
wherein a shape of an outer frame of the second noise filter is different from a shape of an outer frame of the third noise filter.

16. A semiconductor device inspecting apparatus, comprising:
a light source that emits light to a semiconductor pattern;
an objective optical system that passes light therethrough;
a first noise filter including a bar pattern including a plurality of bars separated from each other by a distance, that filters diffraction noise of received light, and that passes the received light therethrough;
a second noise filter that blocks a portion of an image formed by the light that has passed through the first noise filter and includes an opening region and a first blocking region at least partially surrounded by the opening region;
an imaging optical system that receives light from the second noise filter and outputs an image based on the received light; and
a photodetector that receives the image.

17. The semiconductor device inspecting apparatus of claim 16, wherein the first noise filter is operated by a mechanical driving method to adjust the distance between each of the bars of the bar pattern and an area of each of the bars of the bar pattern.

18. The semiconductor device inspecting apparatus of claim 17, wherein the second noise filter includes a central portion including the first blocking region surrounded by an outer frame including the opening region and second blocking regions.

19. The semiconductor device inspecting apparatus of claim 16, wherein each of the first noise filter and the second noise filter includes a spatial light modulator (SLM).

20. The semiconductor device inspecting apparatus of claim 16, wherein the first noise filter and the second noise filter are disposed between the objective optical system and the imaging optical system.
